(19) United States
(12) Patent Application Publication
(10) Pub. No.: US 2020/0358170 A1
(43) Pub. Date: Nov. 12, 2020

(54) BASE STATION ANTENNAS WITH MECHANICAL LINKAGES HAVING FLEXIBLE DRIVE SHAFTS

(71) Applicant: CommScope Technologies LLC, Hickory, NC (US)

(72) Inventor: HORNER Rhys N., Smithfield, New South Wales (AU)

(21) Appl. No.: 16/962,769

(22) PCT Filed: Dec. 18, 2018
(86) PCT No.: PCT/US2018/066178

§ 371 Date: Jul. 16, 2020

Related U.S. Application Data
(60) Provisional application No. 62/634,232, filed on Feb. 23, 2018.

(51) Int. Cl. H01Q 1/24; H01Q 3/08; H01Q 3/36

(52) U.S. Cl. CPC H01Q 1/246; H01Q 3/36; H01Q 3/08

(57) ABSTRACT

Base station antennas include a remote electronic tilt (“RET”) actuator, a phase shifter and a mechanical linkage that extends between the RET actuator and the phase shifter. The mechanical linkage includes at least one guide tube and a monolithic flexible drive shaft that extends through the at least one elongate guide member. The monolithic flexible drive shaft includes at least one bend that is greater than twenty degrees.

### CROSS-REFERENCE TO RELATED APPLICATION

The present application claims priority under 35 U.S.C. § 119 to U.S. Provisional Patent Application Ser. No. 62/634,232, filed Feb. 23, 2018, the entire content of which is incorporated herein by reference as if set forth in its entirety

### FIELD OF THE INVENTION

The present invention relates to communication systems and, in particular, to base station antennas having remote electronic tilt capabilities.

### BACKGROUND

Cellular communications systems are used to provide wireless communications to fixed and mobile subscribers (herein “users”). A cellular communications system may include a plurality of base stations that each provide wireless cellular service for a specified coverage area that is typically referred to as a “cell.” Each base station may include one or more base station antennas that are used to transmit radio frequency (“RF”) signals to, and receive RF signals from, the users that are within the cell served by the base station. Base station antennas are directional devices that can concentrate the RF energy that is transmitted in certain directions (or received from those directions). The “gain” of a base station antenna in a given direction is a measure of the ability of the antenna to concentrate the RF energy in that particular direction. The “radiation pattern” of a base station antenna is compilation of the gain of the antenna across all different directions. The radiation pattern of a base station antenna is typically designed to service a pre-defined coverage area such as the cell or a portion thereof that is typically referred to as a “sector.” The base station antenna may be designed to have minimum gain levels throughout its pre-defined coverage area, and it is typically desirable that the base station antenna have much lower gain levels outside of the coverage area to reduce interference between sectors. Early base station antennas typically had a fixed radiation pattern, meaning that once a base station antenna was installed, its radiation pattern could not be changed unless a technician physically reconfigured the antenna. Unfortunately, such manual reconfiguration of base station antennas after deployment, which could become necessary due to changed environmental conditions or the installation of additional base stations, was typically difficult, expensive and time-consuming.

More recently, base station antennas have been deployed that have radiation patterns that can be mechanically or electronically reconfigured from a remote location by transmitting control signals to the antenna. The most common changes to the radiation pattern are changes in the down tilt angle (i.e., the elevation angle) and/or azimuth angle. The radiation pattern can be changed “mechanically” by transmitting control signals to the antenna that actuate motors that physically move the base station antenna to, for example, change its pointing direction in the azimuth and/or elevation planes. The down tilt or azimuth angle may be changed electronically by transmitting control signals to the antenna that alter the RF signals that are transmitted and received by the antenna. Base station antennas that can have their down tilt angle changed electronically from a remote location are typically referred to as remote electronic tilt (“RET”) antennas, although the term “RET antenna” is now also commonly used to cover antennas that can have their azimuth angle and/or beam width adjusted from a remote location. RET antennas allow wireless network operators to remotely adjust the radiation pattern of the antenna through the use of electro-mechanical actuators that may adjust phase shifters or other devices in the antenna to electronically change the radiation pattern of the antenna.

Base station antennas typically comprise a linear array or a two-dimensional array of radiating elements such as patch, dipole or crossed dipole radiating elements. In order to electronically change the down tilt angle of these antennas, a phase taper may be applied across the radiating elements of the array, as is well understood by those of skill in the art. Such a phase taper may be applied by adjusting the settings on an adjustable phase shifter that is positioned along the RF transmission path between a radio and the individual radiating elements of the base station antenna. One widely-used type of phase shifter is an electromechanical “wiper” phase shifter that includes a main printed circuit board and a “wiper” printed circuit board that may be rotated above the main printed circuit board. Such wiper phase shifters typically divide an input RF signal that is received at the main printed circuit board into a plurality of sub-components, and then capacitively couple at least some of these sub-components to the wiper printed circuit board. The sub-components of the RF signal may be capacitively coupled from the wiper printed circuit board back to the main printed circuit board along a plurality of arc-shaped traces, where each arc has a different diameter. Each end of each arc-shaped trace may be connected to a radiating element or to a sub-group of radiating elements. By physically (mechanically) rotating the wiper printed circuit board above the main printed circuit board, the locations where the sub-components of the RF signal capacitively couple back to the main printed circuit board may be changed, which thus changes the length of the respective transmission path from the phase shifter to an associated radiating element for each sub-component of the RF signal. The changes in these path lengths result in changes in the phases of the respective sub-components of the RF signal, and since the arcs have different radii, the phase changes along the different paths will be different. Typically, the phase taper is applied by applying positive phase shifts of various magnitudes (e.g., +1°, +2° and +3°) to some of the sub-components of the RF signal and by applying negative phase shifts of the same magnitudes (e.g., −1°, −2° and)−3° to additional of the sub-components of the RF signal. Thus, the above-described wiper phase shifters may be used to apply a phase taper to the sub-components of an RF signal that are applied to each radiating element (or sub-group of radiating elements). Exemplary phase shifters of this variety are discussed in U.S. Pat. No. 7,907,096 to Timofeev, the disclosure of which is hereby incorporated herein in its entirety. The wiper printed circuit board is typically moved using an electromechanical actuator such as a DC motor that is connected to the wiper printed circuit board via a mechanical linkage. These actuators are often referred to as RET actuators since they are used to apply the remote electronic down tilt.

### SUMMARY

Pursuant to embodiments of the present invention, base station antennas are provided that include a RET actuator having an output member, a phase shifter having a moveable element and a mechanical linkage that extends between the RET actuator and the phase shifter. The mechanical linkage includes a flexible drive shaft and at least one elongate guide member. At least half of the portion of the flexible drive shaft that is disposed between the output member of the RET actuator and the moveable element of the phase shifter is within an interior of the at least one elongate guide member. Pursuant to other embodiments, the flexible drive shaft may be a monolithic flexible drive shaft and may include at least one bend that is greater than twenty degrees.

In some embodiments, a ninety degree bend radius of the flexible drive shaft is less than 50 millimeters. In other embodiments, a ninety degree bend radius of the flexible drive shaft is less than 40 millimeters. In some embodiments, the flexible drive shaft includes a first bend that extends through at least thirty degrees. In some embodiments, the flexible drive shaft includes at least two bends that each extend through at least twenty degrees. In some embodiments, the flexible drive shaft includes at least two bends, at least one of which is greater than 30 degrees.

In some embodiments, the elongate guide member may be a guide tube. The guide tube may be formed of a flexible material in some embodiments, and may be formed of a rigid material in other embodiments. In some embodiments, the guide tube (or other elongate guide member) may be formed of a material that is settable or curable by an activator such as heat, light, ultraviolet light, chemical additives or the like so that the material initially is flexible but becomes rigid upon activation.

In some embodiments, the mechanical linkage further includes a plurality of guide mounts that hold the elongate guide member in place along a fixed path through the interior of the base station antenna. In some embodiments, the mechanical linkage further comprises a RET actuator connector disposed between an output member of the RET actuator and the flexible drive shaft.

In some embodiments, the flexible drive shaft is configured to move longitudinally within the at least one elongate guide member. In other embodiments, the flexible drive shaft is configured to rotate within the at least one elongate guide member. In some embodiments, the elongate guide member is bundled together with at least one radio frequency cable.

Pursuant to further embodiments of the present invention, base station antennas are provided that include a RET actuator having an output member, a phase shifter having a moveable element and a mechanical linkage extending between the RET actuator and the phase shifter. The mechanical linkage includes a flexible drive shaft and a guide structure. The flexible drive shaft is configured to extend and retract along a fixed path. A first portion of the flexible drive shaft extends through a first bend when the flexible drive shaft is at a first position along the fixed path, and a second, different, portion of the flexible drive shaft extends through a second bend that has the same shape as the first bend when the second portion of the flexible drive shaft is moved into the first position along the fixed path. The mechanical linkage is configured to move the moveable element of the phase shifter in response to movement of the output member of the RET actuator.

In some embodiments, the guide structure comprises a plurality of supports, each support having at least one arm that defines an opening, wherein the flexible drive shaft is routed through the opening. In some embodiments, the at least one arm comprises a pair of opposed arms, and wherein the opening is between the opposed arms. In some embodiments, the at least one arm comprises a ring that defines the opening.

In other embodiments, the guide structure comprises a guide tube and the flexible drive shaft extends through the guide tube.

In some embodiments, the mechanical linkage further comprises a plurality of guide mounts that hold the guide structure in place along a fixed path through the interior of the base station antenna.

Pursuant to further embodiments of the present invention, base station antennas are provided that include A RET actuator, a phase shifter and a mechanical linkage extending between the RET actuator and the phase shifter The mechanical linkage includes at least one elongate guide member and a flexible drive shaft that extends through the at least one elongate guide member. Different portions of the flexible drive shaft are within a first portion of the elongate guide member as the flexible drive shaft is extended or retracted.

The flexible drive shaft may include a first bend that extends through at least thirty degrees. The elongate guide member may include a second bend that has the same shape as the first bend.

### BRIEF DESCRIPTION OF THE DRAWINGS

FIG. 1A is a perspective view of an example base station antenna according to embodiments of the present invention.

FIG. 1B is an end view of the base station antenna of FIG. 1A.

FIG. 1C is a schematic plan view of the base station antenna of FIG. 1A that illustrates the three linear arrays of radiating elements thereof.

FIG. 2 is a schematic block diagram illustrating the electrical connections between various of the components of the base station antenna of FIG. 1.

FIG. 3 is a front perspective view of a pair of electromechanical phase shifters that may be included in the base station antenna of FIG. 1.

FIG. 4A is perspective view of a multi-RET actuator assembly that may be used in base station antennas according to embodiments of the invention.

FIG. 4B is a perspective view of the multi-RET actuator of FIG. 4A with the housing removed therefrom.

FIG. 4C is a perspective view of the actuator included in the multi-RET actuator assembly of FIGS. 4A-4B.

FIG. 4D is a perspective view of the actuator of FIG. 4C with the motors, cam plate and one base plate removed.

FIG. 4E is a side view of the actuator of FIG. 4C.

FIG. 4F is another perspective view of the actuator of FIG. 4C with the motors, cam plate and one base plate removed.

FIG. 5 is a perspective view of the components of a mechanical linkage according to embodiments of the present invention.

FIG. 6A is a perspective view of a flexible drive shaft of the mechanical linkage of FIG. 5.

FIG. 6B is a perspective view of a guide tube of the mechanical linkage of FIG. 5.

FIG. 7A is a perspective view of a guide mount of the mechanical linkage of FIG. 5.

FIG. 7B is an enlarged perspective view illustrating how the guide mount of FIG. 7A may be used to hold two of the guide tubes of FIG. 6B in place.

FIG. 8A is a perspective view of a RET actuator connector of the mechanical linkage of FIG. 5.

FIG. 8B is an enlarged perspective view illustrating the connection between the RET actuator connector of FIG. 8A and the flexible drive shaft of FIG. 6A.

FIG. 8C is a perspective view illustrating the RET actuator connector of FIG. 8A connected between a RET actuator and a flexible drive shaft.

FIG. 9A is a perspective view of a phase shifter connector of the flexible drive shaft assembly of FIG. 5.

FIG. 9B is a perspective view of illustrating the phase shifter connector of FIG. 9A connected between a flexible drive shaft and a pair of phase shifters.

FIG. 10A is a plan view of a base station antenna that includes both mechanical linkages having conventional drive shafts and mechanical linkages having flexible drive shaft assemblies according to embodiments of the present invention.

FIG. 10B is a perspective view of the base station antenna of FIG. 10A.

FIG. 11 is a schematic diagram that illustrates 90°, 180° and 270° bend radiuses for a flexible drive shaft according to embodiments of the present invention.

FIG. 12 is a schematic diagram illustrating a mechanical linkage according to embodiments of the present invention connecting a RET actuator to a pair of phase shifters.

FIG. 13 is a perspective view of a mechanical linkage that includes a flexible drive shaft that rotates in response to movement of a RET actuator.

FIG. 14 is a schematic diagram illustrating a portion of a mechanical linkage according to embodiments of the present invention that includes guide structures in the form of a plurality of ring clips that are used to constrain lateral movement of a flexible drive shaft.

FIG. 15 is a schematic diagram illustrating how the flexible drive shaft may move along a fixed path.

### DETAILED DESCRIPTION

Modern base station antennas often include two, three or more linear arrays of cross-polarized radiating elements. A separate phase shifter is typically provided for each polarization for each linear array. Moreover, in many antennas separate transmit and receive phase shifters are provided (thereby doubling the number of phase shifters) so that the transmit and receive radiation patterns may be independently adjusted. Thus, it is not uncommon for a base station antenna to have eight, twelve or even more adjustable phase shifters for applying remote electronic down tilts to the linear arrays. As described above, RET actuators are provided in the antenna that are used to adjust the phase shifters. While the same down tilt is typically applied to the phase shifters for the two orthogonal polarizations, allowing a single RET actuator and a single mechanical linkage to be used to adjust the phase shifters for both polarizations, modern base station antennas still often need four, six or more RET actuators. The large number of phase shifters and associated RET actuators and mechanical linkages can significantly increase the size, weight and cost of a base station antenna.

Conventionally, a separate RET actuator was provided for each phase shifter (or pair of phase shifters if dual polarized radiating elements are used in a linear array). More recently, RET actuators have been proposed that may be used to move the wiper printed circuit board on as many as twelve phase shifters. For example, U.S. Patent Publication No. 2013/0307728 (“the '728 publication”) discloses a RET actuator that may be used to drive six different mechanical linkages for purposes of adjusting six (or twelve) different phase shifters using one multi-RET actuator.

Mechanical linkages are provided because the RET actuators are typically spaced apart from the phase shifters. The RET actuator is typically controlled to generate a desired amount of movement of an output member thereof. The movement may comprise, for example, linear movement or rotational movement. A mechanical linkage is used to translate the movement of the RET actuator to movement of a moveable element of a phase shifter (e.g., a wiper arm). The mechanical linkage may comprise, for example, one or more plastic or fiberglass rods that extend between the output member of the RET actuator and the moveable element of the phase shifter.

Typically, a mechanical linkage may comprise a series of vertically-extending rods that are connected by horizontally-extending rods that are used to create “jogs” in the mechanical linkage. The jogs allow the mechanical linkage to be routed around other components of the base station antenna that may be interposed along a direct path between the output member of the RET actuator and the moveable element of the phase shifter to which the mechanical linkage is attached. The jogs may also be used to shift the transverse position the distal end of each mechanical linkage to be aligned with the moveable member of a respective one of the phase shifters. As a result, multiple horizontally- and vertically-extending rods may be required for at least some of the mechanical linkages, which increases the weight, cost, volume and complexity of the antenna. Moreover, each vertically-extending rod requires space for the full-scale movement of the RET actuator, which further increases the volume requirement for the antenna. The net result is that designing a base station antenna to include a large number of conventional mechanical linkages within a relatively small volume may be a difficult task, requiring extensive engineering time and design drawings, and the resulting antenna will typically be larger than necessary if an improved mechanical linkage solution was available.

Pursuant to embodiments of the present invention, base station antennas are provided that include mechanical linkages that have one or more flexible drive shafts along with one or more guide structures. The flexible drive shafts may be relatively rigid with respect to forces applied along the longitudinal axis of the drive shafts (i.e., in tension or compression), but may exhibit flexibility with respect to lateral (transverse or bending) forces. This may allow the drive shafts according to embodiments of the present invention to be routed around intervening structures in the base station antenna while still accurately transferring the movement of the output member of the RET actuator to the moveable element of the phase shifter. The guide structure may be flexible in at least a lateral direction so that it can be routed in a non-linear manner within the antenna. A plurality of guide mounts are provided, such as mounting brackets, cable ties or the like, that may be used to hold the guide structures fixedly in place. The guide structure(s) may partially or completely surround the flexible drive shaft to resist lateral movement of the flexible drive shaft in response to movement of the output member of the RET actuator. In other words, the guide mounts hold the guide structure(s) in a fixed position so that a first amount of movement applied to a first end of the flexible drive shaft residing therein will result in a fixed and known change in position of a second end of the flexible drive shaft.

In some embodiments the guide structure(s) may comprise one or more flexible guide tubes or other elongated guide members. The flexible drive shaft may be disposed within the one or more flexible guide tubes/guide members. An inner diameter (or other cross-sectional shape) of each flexible guide tube may be slightly larger than the outer diameter (or other cross-sectional shape) of the flexible drive shaft. This may allow the flexible drive shaft to freely move in the longitudinal direction within the one or more flexible guide tubes while preventing the flexible drive shaft from exhibiting more than de minimis lateral movement. This may ensure that the movement of the output member of the RET actuator is accurately transferred to the moveable element of the phase shifter so that a desired phase shift is achieved.

In some embodiments, each mechanical linkage may include a single flexible drive shaft. In other embodiments, multiple drive shafts may be used to implement at least some of the mechanical linkages, where at least one of the multiple drive shafts is flexible.

The base station antennas according to embodiments of the present invention may include a RET actuator having an output member, a phase shifter having a moveable element and a mechanical linkage that extends between the RET actuator and the phase shifter. In some embodiments, the mechanical linkage includes at least one elongate guide member and a monolithic flexible drive shaft that extends through the at least one elongate guide member, where the monolithic flexible drive shaft includes at least one bend that is greater than twenty degrees. In other embodiments, the mechanical linkage includes a flexible drive shaft and at least one elongate guide member, and at least half of the portion of the flexible drive shaft that is disposed between the output member of the RET actuator and the moveable element of the phase shifter is within an interior of the at least one elongate guide member. In still other embodiments, the mechanical linkage includes a flexible drive shaft and a guide structure (which may or may not be an elongate guide member), and the flexible drive shaft is configured to extend and retract along a fixed path. A first portion of the flexible drive shaft extends through a first bend when the flexible drive shaft is at a first position along the fixed path, and a second, different, portion of the flexible drive shaft extends through a second bend that has the same shape as the first bend when the second portion of the flexible drive shaft is moved into the first position along the fixed path. In each of the above embodiments, the mechanical linkage may be configured to move the moveable element of the phase shifter in response to movement of the output member of the RET actuator.

In some embodiments, a 90° bend radius of the monolithic flexible drive shaft may be less than 50 millimeters. The flexible drive shaft may include one or more bends. Each bend may extend through 20°, 30°, 40° or more. In some embodiments, the monolithic flexible drive shaft includes at least two bends, at least one of which is greater than 30°.

In some embodiments, the mechanical linkage may further include a plurality of guide mounts that hold the guide tube (or other guide structure) in place along a fixed path through the interior of the base station antenna. The mechanical linkage may also include a RET actuator connector disposed between an output member of the RET actuator and the monolithic flexible drive shaft.

The flexible drive shaft may be configured to move longitudinally and/or rotationally within the at least one elongate guide member. In some embodiments, the guide structure may be bundled together with at least one radio frequency cable.

In some embodiments, the guide structure may comprise a plurality of supports, each support having at least one arm (which may be a pair of arms, a ring, etc.) that defines an opening, wherein the flexible drive shaft is routed through the opening.

Embodiments of the present invention will now be discussed in greater detail with reference to the drawings.

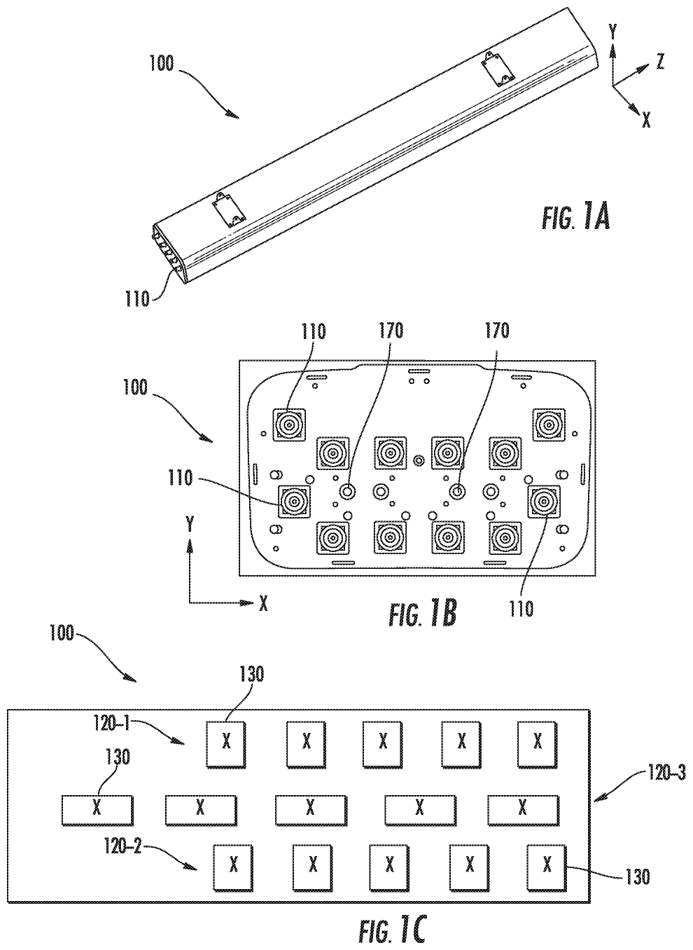

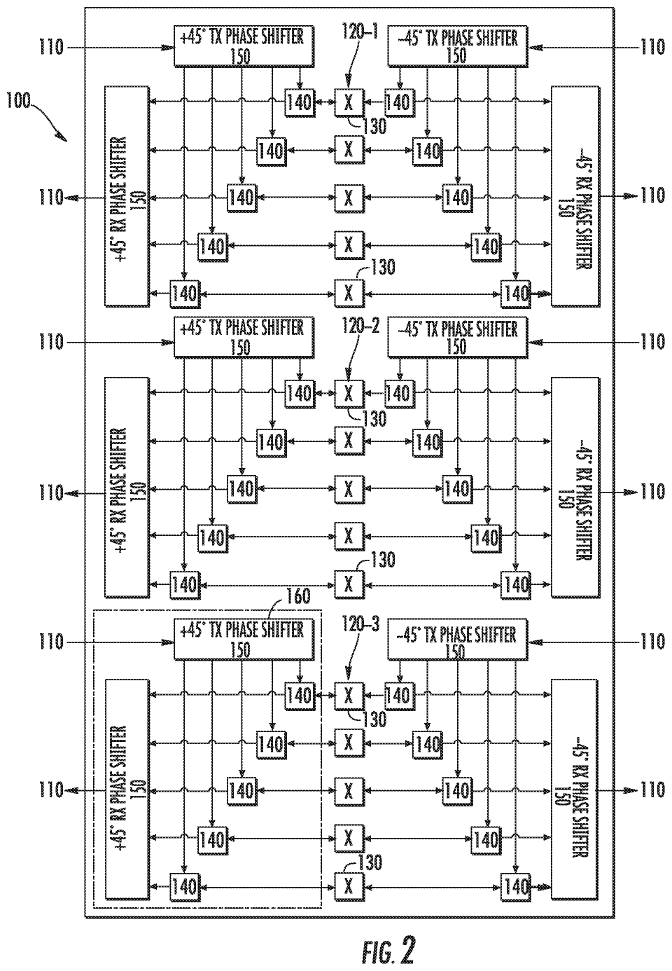

FIG. 1A is a perspective view of a RET base station antenna 100 that may include one or more of the mechanical linkages having flexible drive shafts according to embodiments of the present invention. FIG. 1B is an end view of the base station antenna 100 that illustrates the input/output ports thereof. FIG. 1C is a schematic plan view of the base station antenna 100 that illustrates the three linear arrays of radiating elements thereof. FIG. 2 is a schematic block diagram illustrating various components of the RET antenna 100 and the electrical connections therebetween. It should be noted that FIG. 2 does not show the actual location of the various elements on the antenna, but instead is drawn to merely show the electrical transmission paths between the various elements.

Referring to FIGS. 1A-1C and 2, the RET antenna 100 includes, among other things, input/output ports 110, a plurality of linear arrays 120 of radiating elements 130, duplexers 140, phase shifters 150 and control ports 170. As shown in FIGS. 1C and 2, the antenna 100 includes a total of three linear arrays 120 (labeled 120-1 through 120-3) that each include five radiating elements 130. It will be appreciated, however, that the number of linear arrays 120 and the number of radiating elements 130 included in each of the linear arrays 120 may be varied. It will also be appreciated that different linear arrays 120 may have different numbers of radiating elements 130.

Referring to FIG. 2, the connections between the input/output ports 110, radiating elements 130, duplexers 140 and phase shifters 150 are schematically illustrated. Each set of an input port 110 and a corresponding output port 110, and their associated phase shifters 150 and duplexers 140, may comprise a corporate feed network 160. A dashed box is used in FIG. 2 to illustrate one of the six corporate feed networks 160 included in antenna 100. Each corporate feed network 160 connects the radiating elements 130 of one of the linear arrays 120 to a respective pair of input/output ports 110.

As shown schematically in FIG. 2 by the “X” that is included in each box, the radiating elements 130 may be cross-polarized radiating elements 130 such as +45°/−45° slant dipoles that may transmit and receive RF signals at two orthogonal polarizations. Any other appropriate radiating element 130 may be used including, for example, single dipole radiating elements or patch radiating elements (including cross-polarized patch radiating elements). When cross-polarized radiating elements 130 are used, two corporate feed networks 160 may be provided per linear array 120, a first of which carries RF signals having the first polarization (e.g., +45°) between the radiating elements 130 and a first pair of input/output ports 110 and the second of which carries RF signals having the second polarization (e.g., −45°) between the radiating elements 130 and a second pair of input/output ports 110, as shown in FIG. 2.

As shown in FIG. 2, an input of each transmit (“TX”) phase shifter 150 may be connected to a respective one of the input ports 110. Each input port 110 may be connected to the transmit port of a radio (not shown) such as a remote radio head. Each transmit phase shifter 150 has five outputs that are connected to respective ones of the radiating elements 130 through respective duplexers 140. The transmit phase shifters 150 may divide an RF signal that is input thereto into a plurality of sub-components and may effect a phase taper to the sub-components of the RF signal that are provided to the radiating elements 130. In a typical implementation, a linear phase taper may be applied to the radiating elements 130. As an example, the first radiating element 130 in a linear array 120 may have a phase of Y°+2X°, the second radiating element 130 in the linear array 120 may have a phase of Y°+X°, the third radiating element 130 in the linear array 120 may have a phase of Y°, the fourth radiating element 130 in the linear array 120 may have a phase of Y°-X°, and the fifth radiating element 130 in the linear array 120 may have a phase of Y°-2X°, where the radiating elements 130 are arranged in numerical order.

Similarly, each receive (“RX”) phase shifter 150 may have five inputs that are connected to respective ones of the radiating elements 130 through respective duplexers 140 and an output that is connected to one of the output ports 110. The output port 110 may be connected to the receive port of a radio (not shown). The receive phase shifters 150 may effect a phase taper to the RF signals that are received at the five radiating elements 130 of the linear array 120 and may then combine those RF signals into a composite received RF signal. Typically, a linear phase taper may be applied to the radiating elements 130 as is discussed above with respect to the transmit phase shifters 150.

The duplexers 140 may be used to couple each radiating element 130 to both a transmit phase shifter 150 and to a receive phase shifter 150. As is well known to those of skill in the art, a duplexer is a three port device that (1) passes signals in a first frequency band (e.g., the transmit band) through a first port while not passing signals in a second band (e.g., a receive band), (2) passes signals in the second frequency band while not passing signals in the first frequency band through a second port thereof and (3) passes signals in both the first and second frequency bands through the third port thereof, which is often referred to as the “common” port.

As can be seen from FIG. 2, the base station antenna 100 may include a total of twelve phase shifters 150. While the two transmit phase shifters 150 for each linear array 120 (i.e., one transmit phase shifter 150 for each polarization) may not need to be controlled independently (and the same is true with respect to the two receive phase shifters 150 for each linear array 120), there still are six sets of two phase shifters 150 that should be independently controllable. Accordingly, six mechanical linkages may be required to connect the six sets of phase shifters to respective RET actuators.

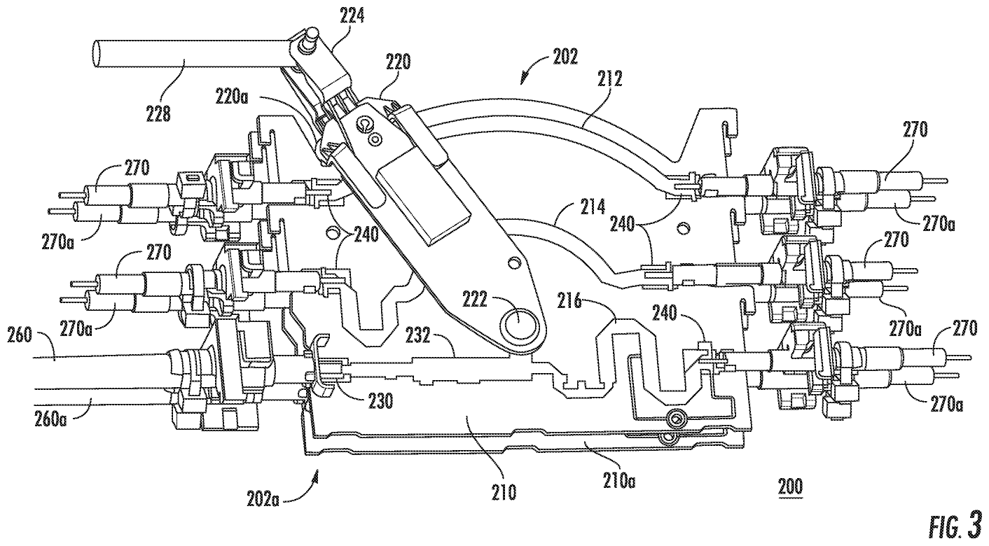

Each phase shifter 150 shown in FIG. 2 may be implemented, for example, as a rotating wiper phase shifter. The phase shifts imparted by a phase shifter 150 to each sub-component of an RF signal may be controlled by a mechanical positioning system that physically changes the position of the rotating wiper of each phase shifter 150, as will be explained with reference to FIG. 3.

Referring to FIG. 3, a dual rotating wiper phase shifter assembly 200 is illustrated that may be used to implement, for example, two of the phase shifters 150 of FIG. 2. The dual rotating wiper phase shifter assembly 200 includes first and second phase shifters 202, 202a. In the description of FIG. 3 that follows it is assumed that the two phase shifters 202, 202a are each transmit phase shifters that have one input and five outputs. It will be appreciated that if the phase shifters 202, 202a are instead used as receive phase shifters then the terminology changes, because when used as receive phase shifters there will be five inputs and a single output.

As shown in FIG. 3, the dual phase shifter 200 includes first and second main (stationary) printed circuit boards 210, 210a that are arranged back-to-back as well as first and second rotatable wiper printed circuit boards 220, 220a (wiper printed circuit board 220a is barely visible in the view of FIG. 3) that are rotatably mounted on the respective main printed circuit boards 210, 210a. The wiper printed circuit boards 220, 220a may be pivotally mounted on the respective main printed circuit boards 210, 210a via a pivot pin 222. The wiper printed circuit boards 220, 220a may be joined together at their distal ends via a bracket 224.

The position of each rotatable wiper printed circuit boards 220, 220a above its respective main printed circuit board 210, 210a is controlled by the position of a drive shaft 228 (partially shown in FIG. 3), the end of which may constitute one end of a mechanical linkage. The other end of the mechanical linkage (not shown) may be coupled to an output member of a RET actuator.

Each main printed circuit board 210, 210a includes transmission line traces 212, 214. The transmission line traces 212, 214 are generally arcuate. In some cases the arcuate transmission line traces 212, 214 may be disposed in a serpentine pattern to achieve a longer effective length. In the example illustrated in FIG. 3, there are two arcuate transmission line traces 212, 214 per main printed circuit board 210, 210a (the traces on printed circuit board 210a are not visible in FIG. 3), with the first arcuate transmission line trace 212 being disposed along an outer circumference of each printed circuit board 210, 210a, and the second arcuate transmission line trace 214 being disposed on a shorter radius concentrically within the outer transmission line trace 212. A third transmission line trace 216 on each main printed circuit board 210, 210a connects an input pad 230 on each main printed circuit board 210, 210a to an output pad 240 that is not subjected to an adjustable phase shift.

The main printed circuit board 210 includes one or more input traces 232 leading from the input pad 230 near an edge of the main printed circuit board 210 to the position where the pivot pin 222 is located. RF signals on the input trace 232 are coupled to a transmission line trace (not visible in FIG. 3) on the wiper printed circuit board 220, typically via a capacitive connection. The transmission line trace on the wiper printed circuit board 220 may split into two secondary transmission line traces (not shown). The RF signals are capacitively coupled from the secondary transmission line traces on the wiper printed circuit board 220 to the transmission line traces 212, 214 on the main printed circuit board. Each end of each transmission line trace 212, 214 may be coupled to a respective output pad 240. A coaxial cable 260 or other RF transmission line component may be connected to input pad 230. A respective coaxial cable 270 or other RF transmission line component may be connected to each respective output pad 240. As the wiper printed circuit board 220 moves, an electrical path length from the input pad 230 of phase shifter 202 to each radiating element 130 served by the transmission lines 212, 214 changes. For example, as the wiper printed circuit board 220 moves to the left it shortens the electrical length of the path from the input pad 230 to the output pad 240 connected to the left side of transmission line trace 212 (which connects to a first radiating element 130), while the electrical length from the input pad 230 to the output pad 240 connected to the right side of transmission line trace 212 (which connects to a second radiating element) increases by a corresponding amount. These changes in path lengths result in phase shifts to the signals received at the output pads 240 connected to transmission line trace 212 relative to, for example, the output pad 240 connected to transmission line trace 216.

The second phase shifter 202a may be identical to the first phase shifter 202. As shown in FIG. 3, the rotating wiper printed circuit board 220a of phase shifter 202a may be controlled by the same drive shaft 228 as the rotating wiper printed circuit board 220 of phase shifter 202. For example, if a linear array 120 includes dual polarized radiating elements 130, typically the same phase shift will be applied to the RF signals transmitted at each of the two orthogonal polarizations. In this case, a single mechanical linkage may be used to control the positions of the wiper printed circuit boards 220, 220a on both phase shifters 202, 202a.

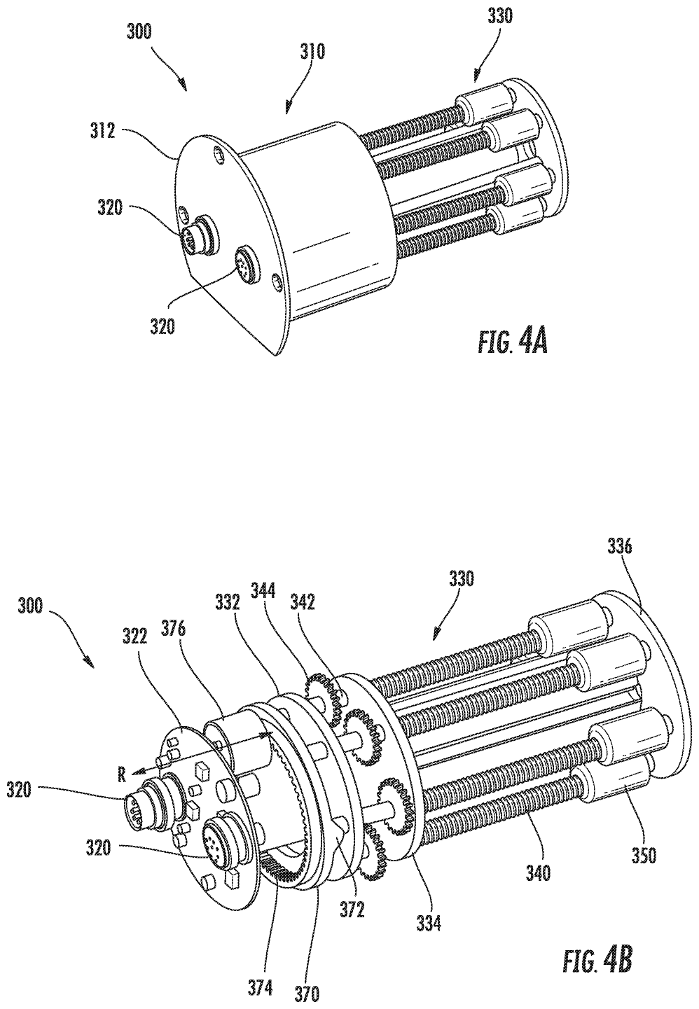

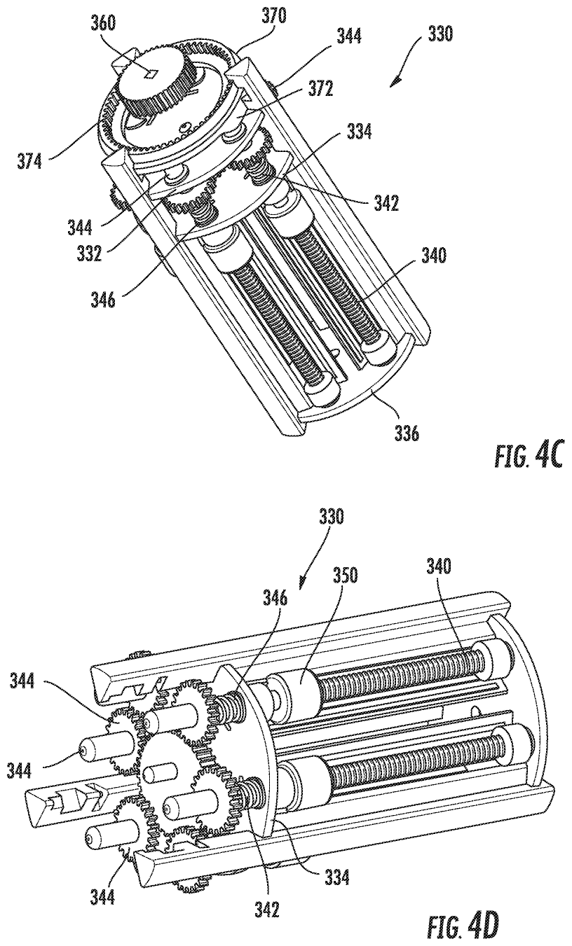

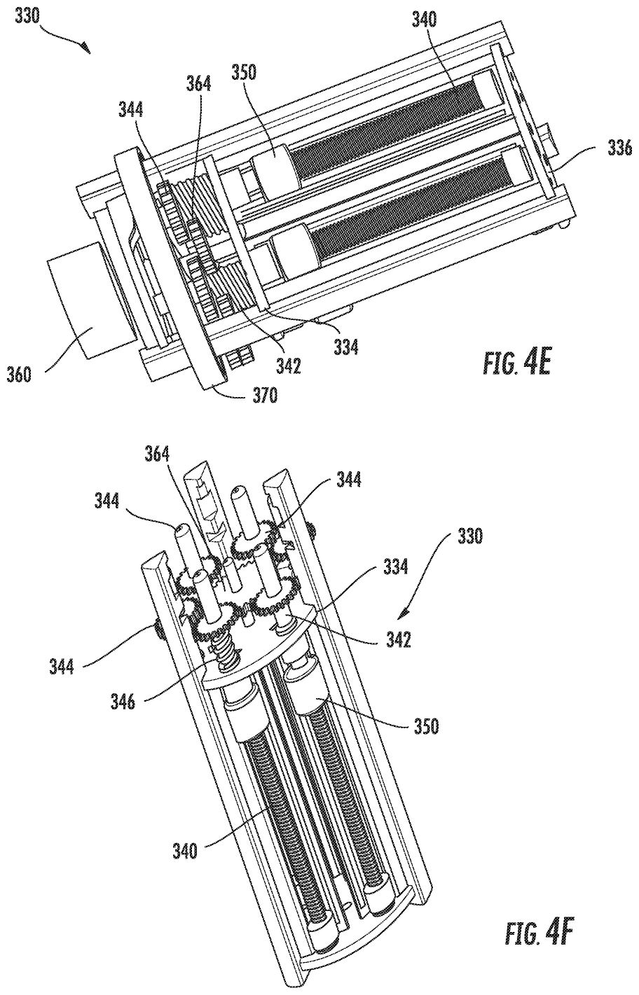

As noted above, the mechanical linkages having flexible drive shafts according to embodiments of the present invention are connected to an output member of a RET actuator. FIGS. 4A-4F illustrate one example RET actuator assembly (in the form of a multi-RET actuators) that may be used in the base station antennas according to embodiments of the present invention. In particular, FIG. 4A is perspective view of the multi-RET actuator assembly 300. FIG. 4B is a perspective view of the multi-RET actuator assembly 300 with the housing removed therefrom. FIG. 4C is a perspective view of a multi-RET actuator 330 that is included in the multi-RET actuator assembly 300. FIG. 4D is a perspective view of the multi-RET actuator 330 with the motors, cam plate and one base plate removed. FIG. 4E is a side view of the multi-RET actuator 330. FIG. 4F is another perspective view of the actuator 330 with the motors, cam plate and one base plate removed.

As shown in FIGS. 4A-4B, the multi-RET actuator assembly 300 includes a housing 310 and a multi-RET actuator 330 that is mounted within the housing 310. The multi-RET actuator 330 includes a printed circuit board 322. A pair of connectors 320 are mounted on the printed circuit board 322 so as to extend through the housing 310. The connectors 320 may connect to communications cables that may be used to deliver control signals from a base station control system to the multi-RET actuator assembly 300.

Referring now to FIGS. 4B-4F, the actuator 330 includes circular base plates 332, 334, 336. Six generally parallel worm gear shafts 340 extend along respective axes between base plates 334 and 336. Each worm gear shaft 340 has a worm gear extension 342 extending from the forward end thereof through base plate 334. The worm gear shafts 340 and their corresponding worm gear extensions 342 are rotatably mounted in the base plate 334. A selector gear 344 is mounted on each worm gear extension 342 so that each worm gear extension 342 extends axially into an internal cavity within its associated selector gear 344. A spring 346 is mounted on each worm gear extension 342 between the base plate 334 and the selector gear 344. Each spring 346 biases its associated selector gear 344 away from the base plate 334 and toward base plate 332, such that a gap exists between each selector gear 344 and the base plate 334. The spring loading of the selector gears 344 by the springs 346 may assist in returning the selector gears 344 to their resting (disengaged) positions after the selector gears 344 are moved into their engaged positions in the manner discussed below

Each selector gear 344 can move axially between the base plates 332, 334 relative to the worm gear extension 342. The end of each worm gear extension 342 may have a cross-section that corresponds to the cross-section of the internal cavity of its corresponding selector gear 344 so that rotation of the selector gear 344 causes corresponding rotation of its associated worm gear extension 342 and worm gear shaft 340. A piston 350 is mounted on each worm gear shaft 340 and is configured (e.g., via threads) to move axially relative to the worm gear shaft 340 upon rotation of the worm gear shaft 340. Each piston 350 may be connected to a mechanical linkage (not shown) that associates the piston 350 with one or more phase shifters of an antenna, such that axial movement of the piston 350 can be used to apply a phase taper to the sub-components of RF signals that are transmitted and received through a linear array of the antenna.

A ringed cam plate 370 is mounted forwardly and spaced apart from base plate 332. The cam plate 370 has a nubbed cam 372 that extends toward the base plate 332. A ring gear 374 with teeth on its inner diameter extends axially from the cam plate 370 and is positioned for rotation about a central axis that extends generally in parallel and in the center of the axes defined by the worm gear shafts 340. A cam plate drive motor 376 is eccentrically mounted to rotate about an eccentric axis R; a gear on a shaft attached to the cam plate drive motor 376 engages the teeth of the ring gear 374.

A stepper gear motor 360 is mounted collinearly with the ring gear 374 forward of the base plate 332. A stepper gear 364 is mounted to a drive shaft 362 of the stepper gear motor 360 and is positioned adjacent the base plate 332 for rotation about the central axis. The stepper gear 364 is positioned in the center of a circle defined by the worm gear shafts 340 and is axially offset from the stepper gears 344 that are mounted on the respective worm gear extensions 342 when the stepper gears 344 are in their resting (disengaged) positions. The stepper gear 364 is sized so that its teeth can engage the teeth of a selector gear 344 when the selector gear 344 is in position adjacent the base plate 334.

In operation, the cam plate 370 is rotated about the central axis to an orientation in which the cam 372 is positioned between the forward ends of two the selector gears 344. When the cam 372 is in this position, all of the selector gears 344 are positioned to be spaced from the base plate 334. Accordingly, all of the selector gears 344 are disengaged from the stepper gear 364, and therefore are not in position to drive any of the worm gear shafts 340. As such, in this disengaged position, all of the pistons 350 remain stationary on their respective worm gear shafts 340.

Upon a signal from a controller that a phase shift in the antenna is desired, the cam plate drive motor 376 is activated and begins to rotate the cam plate 370 about the central axis through interaction between the gear of the cam plate drive motor 376 and the teeth of the ring gear 374. As the cam plate 370 rotates about the central axis, the cam 372 serially engages each of the forward ends of the stepper gears 344 and forces them toward the base plate 334 and into position for engagement with the stepper gear 364. Continued rotation of the cam plate 370 about the central axis moves the cam 372 past the forward end of a respective one of the selector gears 344, allowing the spring loading of the selector gear 344 to return the selector gear 344 to its rest position.

When the cam 372 reaches the forward end of the selector gear 344 associated with the piston 350 that is to be moved to induce the phase shift in the antenna, the cam plate drive motor 376 ceases to move, thereby allowing cam 372 to remain in engagement with the forward end of the selector gear 344. Engagement of the forward end of the selector gear 344 by the cam 372 moves the selector gear 344 rearwardly toward the base plate 334 and into engagement with the stepper gear 364 (this is shown in FIGS. 4D and 4F). The stepper gear motor 360 then activates and rotates the stepper gear 364 about the central axis. Rotation of the stepper gear 364 rotates the engaged selector gear 344 about its respective axis, which in turn rotates the worm gear shaft 340 associated with the selector gear 344. Rotation of the worm gear shaft 340 drives the piston 350 axially along the worm gear shaft 340 until the piston 350 reaches a desired position, at which point the stepper gear motor 360 deactivates. The stepper gear 364 may be rotated in a first direction (e.g., clockwise) to move the pistons 350 on any selected worm gear shaft 340 away from the stepper motor 360, and may be rotated in a second direction (e.g., counter-clockwise) to move the pistons 350 on any selected worm gear shaft 340 toward the stepper motor 360.

As discussed above, conventional mechanical linkages that extend between the outputs of the RET actuator(s) and the phase shifters of a base station antenna may have numerous parts, take up significant room within the antenna, and may be time-consuming to design and implement. Pursuant to embodiments of the present invention, base station antennas are provided that include mechanical linkages having flexible drive shaft assemblies that may be more compact and have fewer parts than conventional mechanical linkages, and which may require less space within the antenna. The mechanical linkages according to embodiments of the invention may also be more freely routed within the antenna, which can significantly simplify the antenna design process.

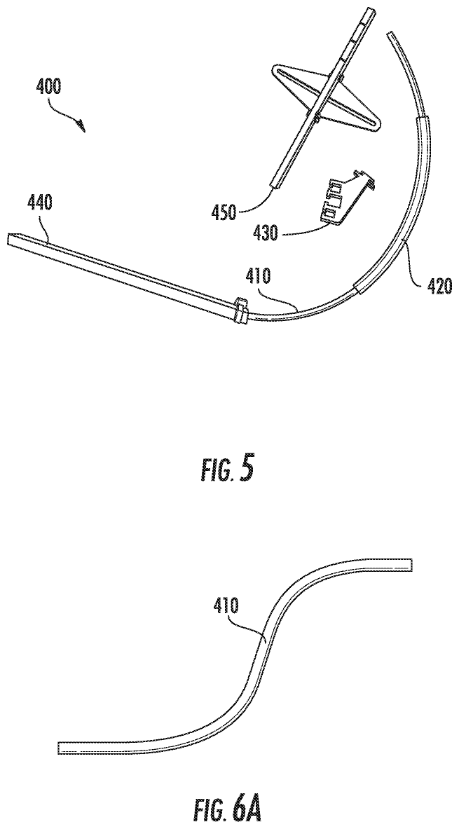

FIG. 5 is a perspective view of the components of a mechanical linkage 400 according to certain embodiments of the present invention. As shown in FIG. 5, the flexible drive shaft assembly 400 includes a flexible drive shaft 410 and one or more guide structures 420. The flexible drive shaft 410 may transfer a movement of an output member of a RET actuator to one or more phase shifters of a base station antenna that includes the mechanical linkage 400. As further shown in FIG. 5, the mechanical linkage 400 may further include one or more guide structure supports 430. As will be discussed in further detail below, the guide mounts 430 may be used to position each guide structure 420 at a desired location within the antenna and to hold each guide structure 420 in its respective position. The mechanical linkage 400 may also include a RET actuator connector 440 that may be used to connect the flexible drive shaft 410 to the output member of the RET actuator. Similarly, the mechanical linkage 400 may include a phase shifter connector 450 that may be used to connect the flexible drive shaft 410 to one or more phase shifters. Each of the above-identified components of the mechanical linkage 400 will now be discussed in greater detail with reference to FIGS. 6A-9B.

Referring first to FIG. 6A, the flexible drive shaft 410 is shown. The flexible drive shaft 410 may be used to transmit mechanical force from an output member of a RET actuator to a moveable element of a phase shifter. The flexible drive shaft 410 may be an elongated member having any appropriate shape. For example, the flexible drive shaft 410 may have a transverse cross-section that is, for example, circular, rectangular, octagonal, or the like (or combinations thereof). The flexible drive shaft 410 may be formed of material(s) such that the flexible drive shaft 410 is relatively rigid (i.e., low compressibility and high tensile modulus) with respect to forces applied along its longitudinal axis, but may exhibit flexibility with respect to lateral forces. This may allow the flexible drive shaft 410 to be routed around intervening structures in the base station antenna while still accurately transferring the movement of the output member of the RET actuator to the moveable element of the phase shifter.

The flexibility of the flexible drive shaft 410 in lateral directions may be quantified in terms of the bend radius of the flexible drive shaft 410. The bend radius of the flexible drive shaft 410 refers to the radius of an arc of a specified number of degrees (e.g., 90°) to which the flexible drive shaft 410 can be bent without damaging the flexible drive shaft 410. Herein, bend radiuses are measured at a temperature of 69.8-77 degrees Fahrenheit. The more flexible a drive shaft is, the smaller the bend radii it may achieve. In some embodiments, the flexible drive shaft 410 may have a 90° bend radius of less than 50 millimeters. In other words, the flexible drive shaft 410 may be bent to extend through an arc of ninety degrees where a radius of the arc is less than 50 millimeters without damaging the flexible drive shaft 410. In other embodiments, the flexible drive shaft may have a 90° bend radius of less than 40 millimeters. The bend radius may be specified for arcs having larger angles. For example, in some embodiments, the flexible drive shaft may have a 180° bend radius of less than 60 millimeters, and/or a 270° bend radius of less than 70 millimeters. FIG. 11 schematically illustrates 90°, 180°, 270° bend radii that are achievable for an example flexible drive shaft according to further embodiments of the present invention.

In some embodiments, a single flexible drive shaft may be provided. In other embodiments, multiple flexible drive shafts may be used that are directly connected to each other and/or that are connected to each other through intervening structures. One or more rigid drive shafts and/or other rigid structures may be interposed within the mechanical linkage so long as the mechanical linkage includes at least one flexible component.

The flexibility of the drive shaft 410 in the lateral direction allows the flexible drive shaft 410 to have curved sections that can be routed around structures in the base station antenna and/or can be routed laterally in the antenna without the need for additional horizontally-extending rods/shafts. The rigidity in the longitudinal direction may ensure that a longitudinal force applied to a first end of the flexible drive shaft 410 will be transferred to the second end of the flexible drive shaft 410.

In some embodiments, the flexible drive shaft 410 may extend through a bend of at least 20°. In other embodiments, the flexible drive shaft 410 may extend through a bend of at least 30°, at least 50°, or at least 60°. In some embodiments, the flexible drive shaft 410 may extend through at least two bends which are each at least 20°. In some embodiments, the flexible drive shaft 410 may extend through at least two bends which are each at least 30°. In each of these embodiments, the flexible drive shaft 410 may be a monolithic structure.

In some embodiments, the flexible drive shaft 410 may comprise a cable such as a coaxial cable. In other embodiments, the flexible drive shaft 410 may comprise a plastic or fiberglass rod. The flexible drive shaft may be formed of any material or combination of materials that exhibits a sufficient degree of flexibility in the lateral direction while maintaining sufficient rigidity in the longitudinal direction. Various plastic and fiberglass materials may be suitable. Materials that are inexpensive and/or lightweight may be preferred, as may materials that have relatively low coefficients of dynamic and static friction. In some embodiments, either or both the flexible drive shaft 410 and the guide structure 420 may have a non-stick coating such as, for example, a PTFE coating, on portions thereof that may come into contact with each other when the flexible drive shaft 410 moves within the guide structure 420 as discussed below. The flexible drive shaft 410 may be corrugated or otherwise have an uneven outer surface to reduce the area of contact between the flexible drive shaft 410 and the guide structure 420 to further reduce friction.

The guide structure(s) 420 may be used to maintain the flexible drive shaft 410 in place along at least two axes. This is shown graphically with reference to FIG. 12. As shown in FIG. 12, the guide structure(s) 420 may define a path between the output member 510 (e.g., a piston 510, which may be mounted on a worm gear shaft 512) of a RET actuator 500 and a moveable element 530 of a phase shifter 520. The guide structures 420 may hold the flexible drive shaft 410 in place so that the flexible drive shaft 410 cannot move along either the x-axis or the y-axis. In other words, the guide structure(s) 420 constrain the flexible drive shaft 410 so that the flexible drive shaft 410 can only move along the z-axis. As a result, if a force (e.g., linear movement of the output member 510 of the RET actuator 500) is applied to a first end 412 of the flexible drive shaft 410, then the same amount of linear movement is applied to a second end 414 of the flexible drive shaft 410 since the flexible drive shaft 410 is constrained by the guide structures 420 from moving in other directions. As such, a first amount of movement applied to the output member 510 of the RET actuator 500 may be designed to consistently provide a second amount of movement to the moveable member 530 of the phase shifter 520. The x-axis, y-axis and z-axis shown in FIG. 12 may correspond to the x-axis, y-axis and z-axis shown in FIGS. 1A and 1B.

In some embodiments (including the embodiment of FIG. 12), the guide structure(s) 420 may comprise one or more elongate guide members 420. The elongate guide members 420 may comprise, for example, guide tubes, guide channels, or other elongate structures that a portion of the flexible drive shaft 410 may extend through. The elongate guide members 420 may maintain a path of the flexible drive shaft. FIG. 6B is an enlarged perspective view of an example guide structure in the form of a guide tube 420 that is included in the mechanical linkage 400 of FIG. 5.

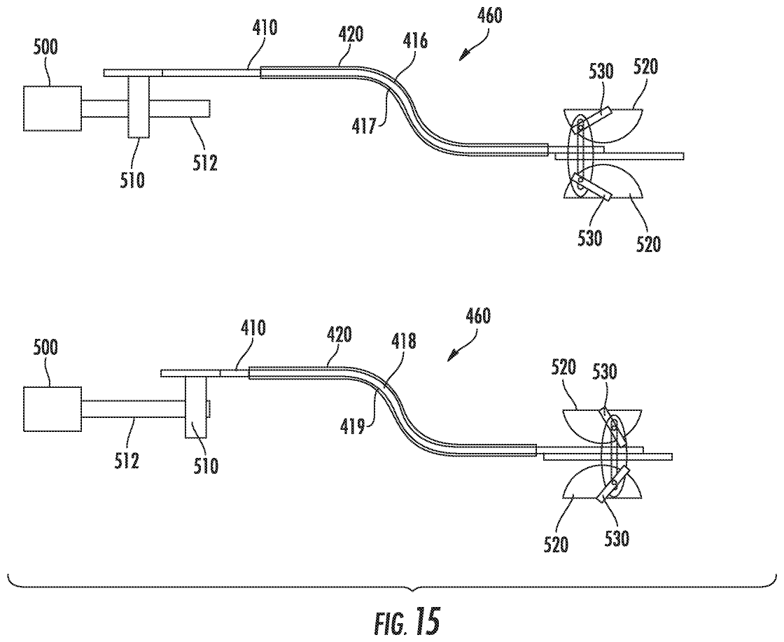

Referring to FIG. 15, it can be seen that the flexible drive shaft 410 is configured to extend and retract along a fixed path 460 that is defined by the guide structure 420 (e.g., a guide tube or other elongate guide member). A first portion 416 of the flexible drive shaft 410 extends through a first bend 417 when the flexible drive shaft 410 is at a first position along the fixed path 460, and a second, different, portion 418 of the flexible drive shaft 410 extends through a second bend 419 that has the same shape as the first bend 417 when the second portion of the flexible drive shaft 410 is moved into the first position along the fixed path 460. Consequently, different portions of the flexible drive shaft 410 are within a first portion of the elongate guide member 420 as the flexible drive shaft 410 is extended or retracted.

As shown in FIG. 6B, in some embodiments, the guide tube 420 may comprise an elongated plastic or fiberglass tube having a sidewall 422 and an open interior 424. The sidewall 422 may comprise a solid sidewall (as shown) or may have openings therein to reduce the amount of material required to form the guide tube 420. While the sidewall 422 extends through a full 360° in the depicted embodiment, it will be appreciated that the sidewall 422 may extend through less than 360° in other embodiments so that the guide tube 420 includes a longitudinal slot (not shown) and is in the form of an elongate guide channel. In some embodiments, the guide tube 420 may be formed of a flexible material that allows the guide tube 420 to be routed through a non-linear path within the antenna. Guide mounts 430 (discussed below) may then be used to fix the guide tube 420 in place. In other embodiments, the guide structure(s) 420 may be rigid structure(s) that include one or more bends. The guide structure(s) 420 may partially or completely surround the flexible drive shaft 410 to resist lateral movement of the flexible drive shaft 410 in response to movement of the output member 510 of the RET actuator 500.

In some embodiments where the guide tube 420 (or other longitudinally-extending guide member) is formed of a flexible material, the guide tube 420 (or other longitudinally-extending guide member) may comprise a heat settable material that may become less flexible (or even rigid) after being heat-treated. In such embodiments, the guide tube 420 may be routed through the antenna while in its flexible state so as to be readily routed around obstacles and/or so as to be readily aligned with its corresponding RET actuator and phase shifter(s). Once the guide tube 420 is in place within the antenna, heat may be applied thereto to render the guide tube more rigid. When the guide tube 420 is rendered more rigid in this manner, the number of guide mounts 430 used to fix the guide tube 420 in place may be reduced. In some cases, any need for guide mounts 430 may be completely eliminated. While the use of heat-settable materials to form the guide tube 420 (or other longitudinally-extending guide member) may be used in some embodiments, it will be appreciated that materials that retain their flexibility may also be used. It will also be appreciated that a wide variety of other materials may be used to provide a guide tube 420 (or other longitudinally-extending guide member) that may be “cured” or “set” once positioned within the antenna along a desired route. For example, materials that can be cured or set (e.g., cross-linked) by light (including ultraviolet light), electron beams, chemical additives, etc. can be used in some embodiments. In still other embodiments, the guide tubes 420 may be formed using memory materials such as shape-memory polymers.

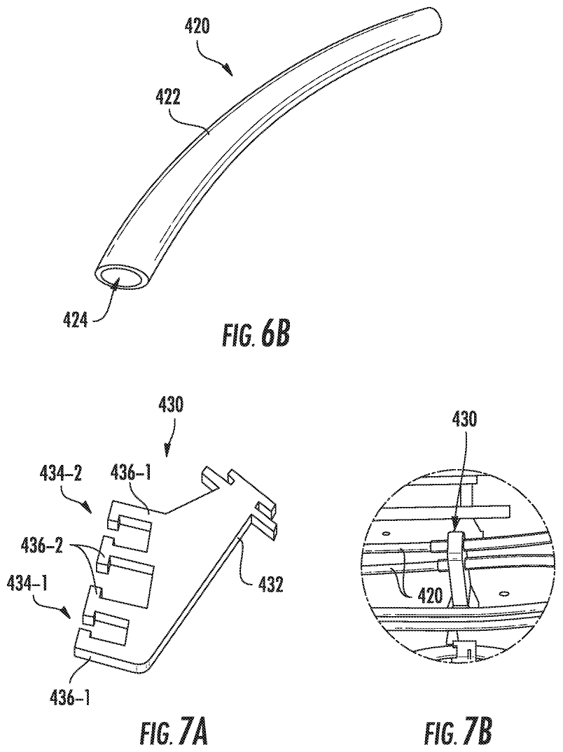

As noted above, a plurality of guide mounts 430 may be used to fix the guide structure(s) 420 in place. Herein, the term “guide mount” is used broadly to encompass any bracket, clip, tie, arm, hook, latch, eyelet or the like that is used to maintain the guide structure 420 in a fixed position. FIG. 7A is a perspective view of an example guide mount 430 in the form of a mounting bracket, while FIG. 7B is an enlarged perspective view illustrating how the mounting bracket 430 of FIG. 7A may be used to hold two of the guide tubes 420 of FIG. 6B in place.

As shown in FIGS. 7A-7B, the mounting bracket 430 may comprise, for example, a plastic or fiberglass structure that has a base 432 that is mounted to a housing structure or other element of a base station antenna. The mounting bracket 430 further includes a pair of clips 434-1, 434-2, each of which has first and second arms 436-1, 436-2 extending from the base 432. The arms 436 and/or the base 432 may be configured to surround more than half the circumference of the guide tube 420 so that each guide tube 420 may be locked within the arms 436 of a respective clip 434. The clips 434 may be designed to avoid tightly pinching the guide tube 420 so that the mounting bracket 430 and guide tube 420 do not interfere with longitudinal (or rotational) movement of the flexible drive shaft 410.

It will be appreciated that a wide variety of guide mounts 430 may be used. For example, as discussed below with reference to FIG. 13, in some embodiments, ring clips may be used as the guide structures 430 rather than a guide tube 420. In such embodiments, the ring portion of the ring clips may be the guide structures 420 and the bases of the ring clips may be the guide mounts 430.

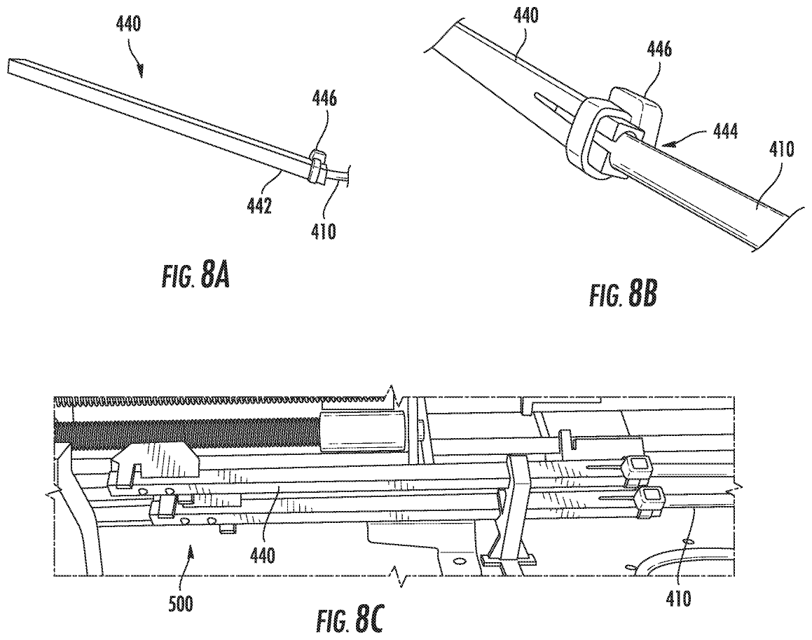

In some embodiments, the flexible drive shaft 410 may directly connect to an output member 510 of the RET actuator 500. In other embodiments, a connecting structure may be disposed between the output member 510 of the RET actuator 500 and the flexible drive shaft 410. FIG. 8A is a perspective view of a RET actuator connector 440 of the mechanical linkage 400 of FIG. 5 that acts as such a connecting structure. FIG. 8B is an enlarged perspective view illustrating the connection between the RET actuator connector 440 of FIG. 8A and the flexible drive shaft 410. FIG. 8C is a perspective view illustrating the RET actuator connector 440 of FIG. 8A connected between an output member 510 of a RET actuator 520 and a flexible drive shaft 410.

As shown in FIGS. 8A-8C, the RET actuator connector 440 may comprise a rigid shaft that is attached between the output member 510 of the RET actuator 500 and the flexible drive shaft 410. Movement of the output member 510 thus is transferred to the RET actuator connector 440, which in turn transfers that movement to the flexible drive shaft 410. The RET actuator connector 440 may be attached or connected to the output member 510 of the RET actuator by any appropriate mechanism including, for example, snap clips, screws, adhesives or the like. In the depicted embodiment, snap clips are used. Likewise, the RET actuator connector 440 may be connected to the flexible drive shaft 410 in a wide variety of ways. In the depicted embodiment, a distal end 442 of the RET actuator connector 440 includes an opening 444 that receives an end of the flexible drive shaft 410. A cable tie, band, clamp or the like 446 is tightened around the distal end 442 of the RET actuator connector 440 to hold the first end 412 of the flexible drive shaft 410 within the opening 444. As shown, in some embodiments, a longitudinal axis of a first end 412 of the flexible drive shaft 410 may be aligned (co-linear) with a longitudinal axis of the RET actuator connector 440. The RET actuator connector 440 may be provided because in some cases if the flexible drive shaft 410 is connected directly to the output member 510 of the RET actuator 500, then the output member 510 may pivot at its attachment point to another element (e.g., a worm gear shaft) of the RET actuator 500 creating “backlash” that may weaken or damage components of the RET actuator 500. The provision of the RET actuator connector 440 may reduce or eliminate such backlash. However, it will be appreciated that in some embodiments the flexible drive shaft 410 may be connected directly to the output member 510 of the RET actuator 500 without any intervening RET actuator connector 440. The RET actuator connector 440 may be a monolithic element or may have multiple parts.

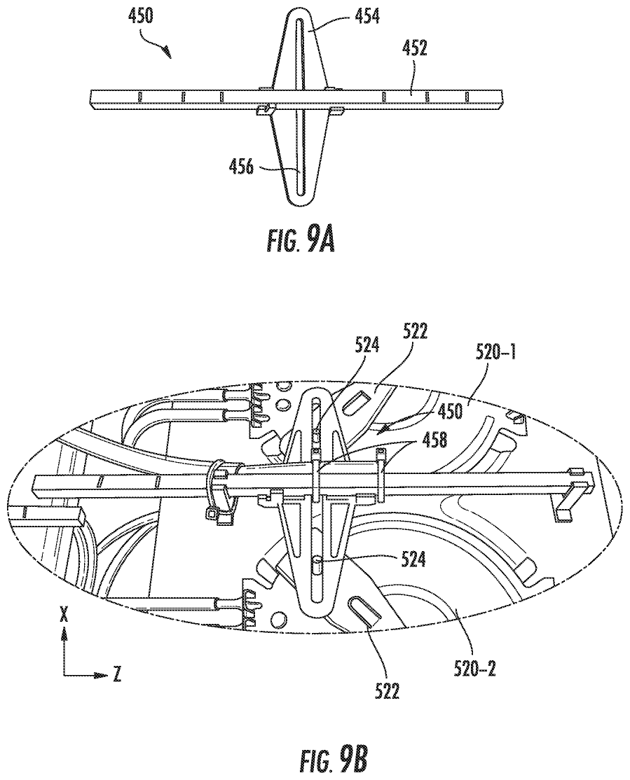

In some embodiments, the flexible drive shaft 410 may connect directly to a moveable member 530 of a phase shifter 520. In other embodiments, a phase shifter connector 450 may be provided that is interposed between the flexible drive shaft 410 and the moveable member 530 of the phase shifter 520. FIG. 9A is a perspective view of a phase shifter connector 450 of the mechanical linkage 400 of FIG. 5. FIG. 9B is a perspective view illustrating the phase shifter connector 450 of FIG. 9A connected between the flexible drive shaft 410 and a pair of phase shifters 520-1, 520-2.

As shown in FIGS. 9A-9B, the phase shifter connector 450 includes a connector rod 452 and a slider 454. The connector rod 452 may comprise, for example, a plastic or fiberglass rod. The second end 414 of the flexible drive shaft 410 may be connected to the connector rod 452 using any appropriate means. In the depicted embodiment, several cable ties 458 are used, but clamps, snap clips, screws, rivets, adhesives or any other appropriate attachment mechanism may be used in further embodiments. The slider 454 may be attached to the connector rod 452. In the depicted embodiment, snap clips are used as the attachment mechanism, but other attachment mechanisms may be used. Alternatively, the connector rod 452 and the slider 454 may be implemented as a monolithic component. The slider 454 includes a slot 456. Nubs 524 that are included on the wiper printed circuit boards 522 of the phase shifters 520-1, 520-2 are received within the respective slots 456. Longitudinal movement (i.e., movement along the z-axis direction) of the connector rod 452 (in response to longitudinal movement of the flexible drive shaft 410) results in movement of the slider 454, which in turn exerts forces on the nubs 524, which acts to rotate the wiper printed circuit boards 522, thereby effecting a phase shift.

The phase shifter connector 450 is designed to work with a pair of side-by-side phase shifters 520. It will be appreciated that the design of the phase shifter connector 450 will be changed to operate with other phase shifter configurations such as, for example, a single phase shifter or a pair of back-to-back phase shifters such as shown in FIG. 3. For example, in those embodiments the slider 454 may be omitted. Any appropriate phase shifter connector 450 may be used. Also, the phase shifter connector 450 may be omitted in some embodiments.

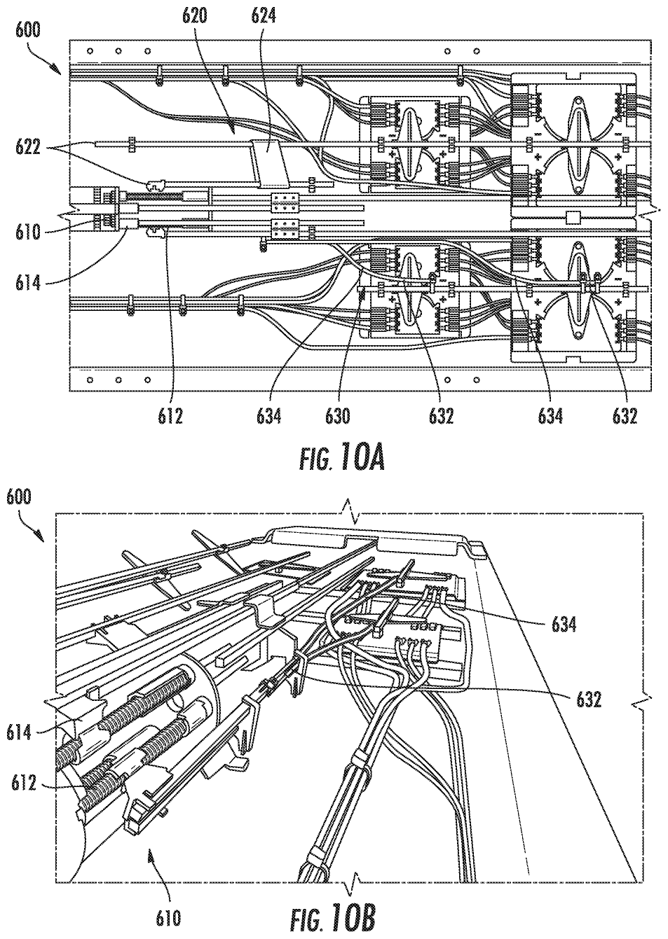

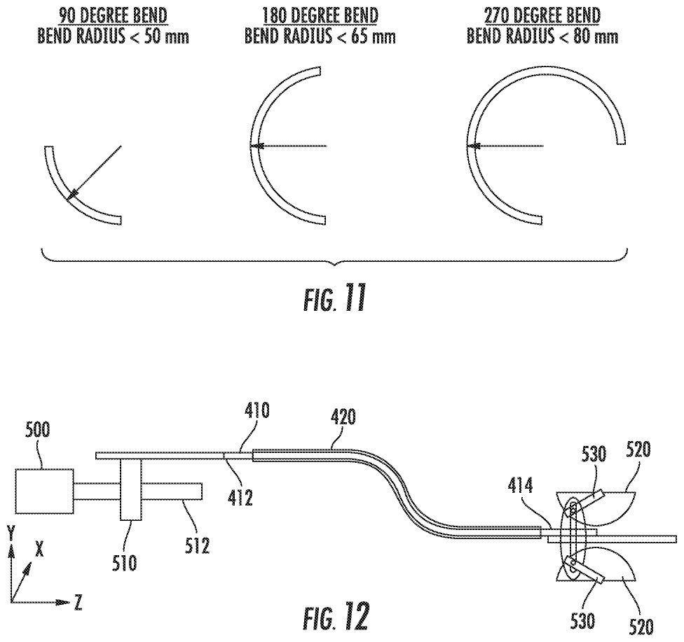

FIG. 10A is a plan view of a base station antenna 600 that includes both mechanical linkages having conventional drive shafts and mechanical linkages having flexible drive shafts according to embodiments of the present invention. FIG. 10B is a perspective view of the base station antenna 600 of FIG. 10A.

Referring to FIGS. 10A-10B, it can be seen that the base station antenna 600 includes a multi-RET actuator 610 having the design of the multi-RET actuator 300 of FIGS. 4A-4F. The multi-RET actuator 610 has a total of six output members 614 in the form of internally-threaded pistons that are mounted on respective worm gear shafts 612. Each piston 614 may move longitudinally along its respective worm gear shaft 612 in the manner discussed above with reference to FIGS. 4A-4F. As can be seen in FIG. 10A, four of the pistons 614 are connected to conventional mechanical linkages 620 that each comprise one or more generally rigid fiberglass vertically-extending (i.e., longitudinally-extending) rods 622. The two conventional mechanical linkages closest to the top of FIG. 10A further include respective horizontally-extending (i.e., transversely-extending) rods or connectors 624. In order to avoid other elements of the base station antenna 600, the conventional mechanical linkages 620 may extend over top of the elements (in the view of FIG. 10A) which may increase the required volume of the antenna 600. Additionally, each vertically-extending rod 622 must have clearance on either end thereof for the rod 622 to move through the full range of motion of its associated piston 614. This may further increase the total volume required for the mechanical linkage 620. Additionally, the antenna design must account for providing room for the mechanical linkages 620, which may complicate the design process.

FIGS. 10A-10B also illustrate two mechanical linkages 630 according to embodiments of the present invention that have flexible drive shafts 632 which run through respective guide tubes 634. As can be seen in FIGS. 10A-10B, the flexible drive shafts 632 may be routed around obstacles and hence need not extend above the other elements of the base station antenna 600. This may allow for more compact base station antenna designs. Additionally, there tends to be sufficient open area within base station antenna 600 such that a flexible drive shaft 632 (along with its associated guide structures 634) can be readily routed through the antenna 600 after the other elements of the antenna 600 have been designed, so that the antenna design process need not consider the mechanical linkage routing as an initial consideration. This may simplify the design process. In fact, in many cases, significant portions of the guide structures 634 may be routed with the RF cables through the antenna 600, and may even be attached to the RF cables via cable ties in some embodiments.

The mechanical linkages according to embodiments of the present invention may allow greater flexibility in the placement of phase shifters within the antenna, which may further simplify the design process and/or increase the compactness of the antenna. The mechanical linkages according to embodiments of the present invention also tend to be less complex than conventional mechanical linkages.

The mechanical linkage 400 illustrated above in FIGS. 5-9B is used to transfer a linear movement of the output member 510 of the RET actuator 500 to a slider 454 that rotationally moves a wiper arm 522 of a phase shifter 520. It will be appreciated, however, that other types of movement may be transferred between an output member of a RET actuator and a phase shifter using the mechanical linkages according to embodiments of the present invention. For example, FIG. 13 illustrates a portion of a mechanical linkage 700 having a flexible drive shaft 710 extending through a guide structure 720, which in FIG. 13 is shown as a guide tube. A RET actuator (not shown) transfers a rotational movement to the flexible drive shaft 710. A distal end 714 of the flexible drive shaft 710 (i.e., the end that is remote from the RET actuator) is attached to a worm gear shaft 720 that has an internally-threaded piston 730 mounted thereon. The worm gear shaft 720 and piston 730 may be formed of non-metallic materials such as fiberglass. Rotation of the flexible drive shaft 710 results in rotation of the worm gear shaft 720. Rotation of the worm gear shaft 720 causes the piston 730 to move longitudinally along the worm gear shaft 720. A phase shifter connector 740 that includes a slider 742 is attached to the piston. Longitudinal movement of the slider 742 causes the wiper printed circuit boards 752 of a pair of phase shifters 750 to rotate.

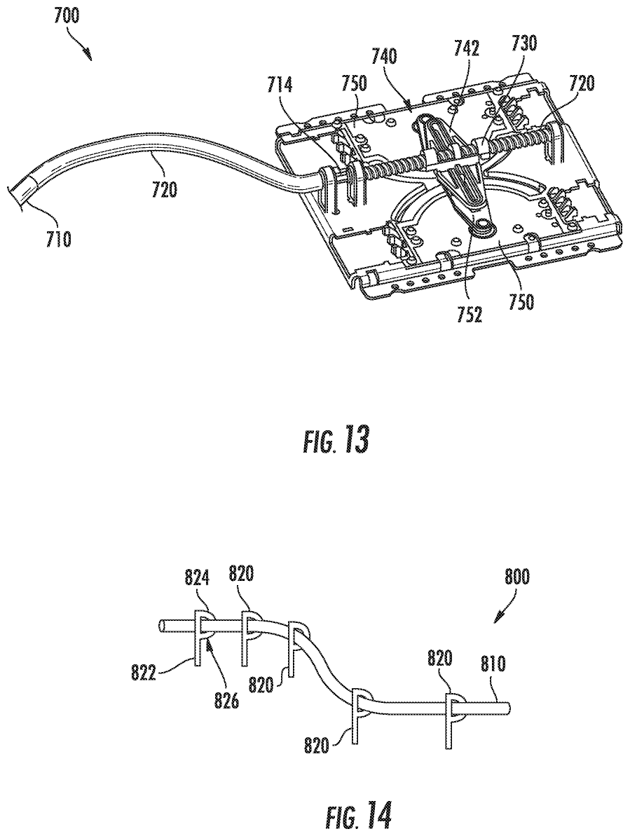

FIG. 14 is a schematic diagram illustrating a portion of a mechanical linkage 800 according to embodiments of the present invention that includes guide structures in the form of a plurality of D-ring clips 820 that are used to constrain lateral movement of a flexible drive shaft 810. Each D-ring clip 820 may comprise a base 822 and a pair of joined arms 824 that extend from an upper portion of the base 822 to define an opening 826. The opening 826 may be any appropriate shape such as square, circular, semi-circular. The flexible drive shaft 810 may extend through the openings 826 defined by the D-ring clips 820 so that the arms 824 of the D-ring clips 820 constrain lateral movement of the flexible drive shaft 810. A relatively large number of D-ring clips 820 may be provided. The bottom portion of the base 822 of each D-ring clip 820 may be mounted on or in another structure of a base station antenna such as a reflector or housing structure. It will be appreciated that any other suitable guide structure may be used such as, for example, O-ring clips, hose clamps, guide tube clamp, P-clips and the like.

In some embodiments of the present invention, the flexible drive shafts may have no more than five sharp bends (i.e., bends of more than 45 degrees per 100 millimeters). Additionally or alternatively, in some embodiments, the flexible drive shafts may have no more than 450° of cumulative angular bending. These design parameters may help ensure that the flexible drive shaft freely moves within the guide structures, as may the use of low friction coating on either or both the outer surface of the flexible drive shaft and/or inner surfaces of the guide structures. The guide structure may (e.g., a guide tube) may be fixed to other elements of the antenna at intervals of no more than 250 mm in some embodiments to ensure that the guide structure remains sufficiently fixed. Minimum intervals of 200 mm, 300 mm or 400 mm may be used in other embodiments.

Pursuant to further embodiments of the present invention, methods of adjusting a down tilt of a base station antenna are provided. Pursuant to these methods, movement of a remote electronic downtilt (“RET”) actuator may be transferred to a mechanical linkage that includes a flexible drive shaft and at least one guide structure. The flexible drive shaft extends through the guide structure so that the guide structure may constrain movement of the flexible drive shaft in all but the longitudinal direction. The flexible drive shaft includes at least one curved section. The motion of the flexible drive shaft may be imparted (either directly or indirectly) to a moveable element of a phase shifter in order to adjust, for example, a down tilt pointing angle of the antenna. These methods may be implemented using any of the mechanical linkages according to embodiments of the present invention that are disclosed herein.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Herein, the terms “attached”, “connected”, “interconnected”, “contacting”, “mounted” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

1. A base station antenna, comprising:
a remote electronic tilt (“RET”) actuator;
a phase shifter; and
a mechanical linkage extending between the RET actuator and the phase shifter, the mechanical linkage including at least one elongate guide member and a monolithic flexible drive shaft that extends through the at least one elongate guide member,
wherein the monolithic flexible drive shaft includes at least one bend that is greater than twenty degrees.

2. The base station antenna of claim 1, wherein the elongate guide member is a guide tube.

3. The base station antenna of claim 1, wherein a ninety degree bend radius of the monolithic flexible drive shaft is less than 50 millimeters.

4. The base station antenna of claim 1, wherein the monolithic flexible drive shaft includes at least a first bend and a second bend, at least one of which is greater than 30 degrees.

5. The base station antenna of claim 4, wherein the elongated guide member includes a third bend that has the same shape as the first bend and a fourth bend that has the same shape as the second bend.

6. The base station antenna of claim 1, wherein the mechanical linkage further comprises a plurality of guide mounts that hold the elongate guide member in place along a fixed path through the interior of the base station antenna.

7. The base station antenna of claim 1, wherein the guide tube is formed of a curable or settable material.

8-11. (canceled)

12. A base station antenna, comprising:
a remote electronic tilt (“RET”) actuator having an output member;
a phase shifter having a moveable element; and
a mechanical linkage extending between the RET actuator and the phase shifter, the mechanical linkage including a flexible drive shaft and a guide structure,
wherein the flexible drive shaft is configured to extend and retract along a fixed path, and
wherein a first portion of the flexible drive shaft extends through a first bend when the flexible drive shaft is at a first position along the fixed path, and a second, different, portion of the flexible drive shaft extends through a second bend that has the same shape as the first bend when the second portion of the flexible drive shaft is moved into the first position along the fixed path,
wherein the mechanical linkage is configured to move the moveable element of the phase shifter in response to movement of the output member of the RET actuator.

13. The base station antenna of claim 12, wherein the guide structure comprises a plurality of supports, each support having at least one arm that defines an opening, wherein the flexible drive shaft is routed through the opening.

14. The base station antenna of claim 13, wherein the at least one arm comprises a pair of opposed arms, and wherein the opening is between the opposed arms.

15. The base station antenna of claim 13, wherein the at least one arm comprises a ring that defines the opening.

16. The base station antenna of claim 12, wherein the guide structure comprises an elongate guide member and the flexible drive shaft extends through the elongate guide member.

17-21. (canceled)

22. The base station antenna of claim 16, wherein the first bend that extends through at least thirty degrees.

23. The base station antenna of claim 22, wherein the elongate guide member includes a third bend that has the same shape as the first bend.

24-27. (canceled)

28. The base station antenna of claim 16, wherein the elongate guide member is bundled together with at least one radio frequency cable.

29-38. (canceled)

39. A base station antenna, comprising:
a remote electronic tilt (“RET”) actuator;
a phase shifter; and
a mechanical linkage extending between the RET actuator and the phase shifter, the mechanical linkage including at least one elongate guide member and a flexible drive shaft that extends through the at least one elongate guide member,
wherein different portions of the flexible drive shaft are within a first portion of the elongate guide member as the flexible drive shaft is extended or retracted.

40. The base station antenna of claim 39, wherein the elongate guide member is a guide tube.

41-42. (canceled)

43. The base station antenna of claim 39, wherein the flexible drive shaft includes a first bend that extends through at least twenty degrees.

44. The base station antenna of claim 43, wherein the elongate guide member includes a second bend that has the same shape as the first bend.

45. The base station antenna of claim 39, wherein the flexible drive shaft is configured to move longitudinally within the guide structure.

46. The base station antenna of claim 39, wherein the flexible drive shaft is configured to rotate within the guide structure.

47. (canceled)
